(19) United States
(12) Patent Application Publication
(10) Pub. No.: US 2014/0007477 A1
(43) Pub. Date: Jan. 9, 2014

(54) TAGS FOR LABELING OBJECTS

(71) Applicant: Twigo LLC, Hoboken, NJ (US)

(72) Inventors: Janine Berger, Hoboken, NJ (US); Frederic Gillet, Hoboken, NJ (US)

(21) Appl. No.: 13/926,951

(22) Filed: Jun. 25, 2013

Related U.S. Application Data
(60) Provisional application No. 61/663,932, filed on Jun. 25, 2012.

(51) Int. Cl. G09F 3/04; B41M 7/00; B29C 45/00

(52) U.S. Cl. CPC G09F 3/04; B29C 45/0003; B41M 7/0027
USPC 40/665; 264/250; 427/256

(57) ABSTRACT

A tag for labeling an object includes a body and an elastic band formed integrally with the body. The body includes two main opposing outer surfaces and a peripheral surface therebetween, and the band extends substantially from one side of the peripheral surface of the body to form a closed loop. The body and the band can be made from silicone, and are configured such that the band can be wrapped around an appendage of the object to allow the body to be inserted through the loop, thereby forming a knot that secures the tag onto the object. The knot can be untied by loosening the band and pulling the body back out through the loop. A method of manufacturing the tag, as well as methods of using the tag, is also disclosed.

### CROSS REFERENCES TO RELATED APPLICATIONS

This application claims priority to U.S. Provisional Application No. 61/663,932, filed Jun. 25, 2012, the disclosure of which is incorporated by reference herein in its entirety.

### BACKGROUND OF THE INVENTION

1. Field of the Invention

The present invention relates to a tag to label objects, including pets, backpacks and/or other types of luggage, and, more specifically, to a system and product for labeling objects with a tag wherein the label includes a writing surface.

2. Description of Related Art

Tags currently available on the market are generally made from metal, enamel, leather or plastic. Metal and enamel tags are often noisy, are not weather or waterproof and may leave unsightly dirty marks on pets, luggage or those handling the tags. Additionally, metal tags can bend. Leather tags are expensive and are not waterproof, and plastic tags can break easily. For labeling and identification, some tags require engraving, which fades over time with wear. Other tags have a transparent pouch in which a piece of paper, such as a business card, can be placed. In these tags, the paper label gets creased if the tag bends and ruined if water enters the pouch.

A beverage identifier described in U.S. patent application Ser. No. 12/728,447 generally includes a one-piece body that can be made from a stretchable material for removably securing around a beverage container and a writing surface on the one-piece body. This beverage identifier is not suited for labeling pets, luggage or other objects because, among other things, the one-piece body lacks a distinct attaching mechanism and can only wrap around a tubular or cylindrical object much like a wrist watch being worn by a person. As the body of the identifier forms part of the ring wrapping around the object, the body may stretch or contract when placed on objects of different sizes causing the writing surface, and the text or label on the writing surface, to either distort or appear disproportionate to the rest of the body.

### SUMMARY OF THE INVENTION

In some embodiments, a tag for labeling an object is provided, which includes a body and an elastic band integrally formed with the body. The body includes two main opposing outer surfaces and a peripheral surface therebetween, and the elastic band extends substantially from one side of the peripheral surface of the body to form a closed loop. The body and the band are configured and constructed such that the band can be placed around an appendage of the object to allow the body to be inserted through an opening formed by a portion of the loop and the appendage, thereby forming a knot that secures the tag onto the object.

The band can be joined with the body at a common joint end (i.e., the band itself forms a closed loop), or the band includes two ends each separately extending from the a same side of the peripheral surface of the body (in which case, the band and a portion of the peripheral surface together form a closed loop).

In some embodiments, the band is made from silicone. In one embodiment, the body and the band both comprises silicone, e.g., they can be formed as a one-piece structure by injecting silicone into a mold. In one embodiment, the body is substantially planar. In one embodiment, the band has a cross section of a substantially round shape. The dimension of the cross section of the band can be approximately equal to, or slightly smaller than the thickness of the body.

In some embodiments, one of the main surfaces of the body can include a writing surface adapted to be written upon by a user using a writing device (e.g., a ball point pen). The writing surface can include a polyurethane coating. In one embodiment, the main surface that includes the writing surface has a color different from that of the other of the main surfaces.

In some embodiments, the body includes an internal cavity adapted to receive a pre-existing tag. An opening for the cavity can be provided on a portion of the peripheral surface, or on one of the main outer surfaces of the body, for inserting the pre-existing tag.

In some embodiments, a tag that includes a pocket for protecting pre-existing tags is provided. The pocketed tag can include a band as described herein as an attaching mechanism, but can also be without the attaching mechanism.

In some embodiments, a method for making a tag for labeling objects is provided. In the method, a first injectable material, such as silicone, is injected into a first injection mold to form a base shape, which includes a body having two main opposing outer surfaces and a peripheral surface therebetween, and a band integrally formed with the body as one piece and extending substantially from one side of the peripheral surface of the body to form a closed loop. The base shape is then transferred into a second injection mold, the second injection mold including remaining space for receiving further injectable material at one side of one main outer surface of the body. Additional injectable material (such as silicone or other material, mixed with desired pigment or other coloration materials if desired) can then be injected into the remaining space in the second injection mold to form surface features on one main outer surface of the body.

In further embodiments, a method for using the tag herein described is provided. The method includes placing the band around an appendage of an object, inserting the body through an opening formed between a portion of the loop and the appendage, and tightening the loop to form a knot that secures the tag onto the object. In one embodiment, where one of the main surfaces of the tag includes a writing surface which includes a polyurethane coating, the method further includes writing on the polyurethane coating using an oil-based ink; and heating the body of the tag or the entire tag to cure the writing into the coating, thereby improving the durability of the indicia. In one embodiment, the polyurethane coating can be prepared by a water-based UV-curable polyurethane dispersion.

### BRIEF DESCRIPTION OF THE DRAWINGS

The foregoing summary, as well as the following detailed description of certain embodiments of the present invention will be better understood when read in conjunction with the appended drawings. It should be understood, however, that the present invention is not limited by any of the representations in the figures shown. In the drawings:

FIG. 1A shows variants of a tag according to some embodiments of the present invention;

FIG. 1B shows other variants of a tag according to some embodiments of the present invention;

FIG. 2A shows a front view of a tag according to one embodiment of the present invention;

FIG. 2B shows a rear view of a tag according to one embodiment of the present invention;

FIG. 3A shows a front view of a tag according to one embodiment of the present invention;

FIG. 3B shows a rear view of the tag shown in FIG. 3A;

FIG. 4 shows dimensioned views of a tag according to one embodiment of the present invention;

FIG. 5 shows dimensioned views of another tag according to one embodiment of the present invention;

FIG. 6 shows dimensioned views of a tag containing a pocket according to one embodiment of the present invention; and

FIG. 7 shows dimensioned views of a pocketed tag having an attaching mechanism according to one embodiment of the present invention.

### DETAILED DESCRIPTION OF CERTAIN EMBODIMENTS OF THE INVENTION

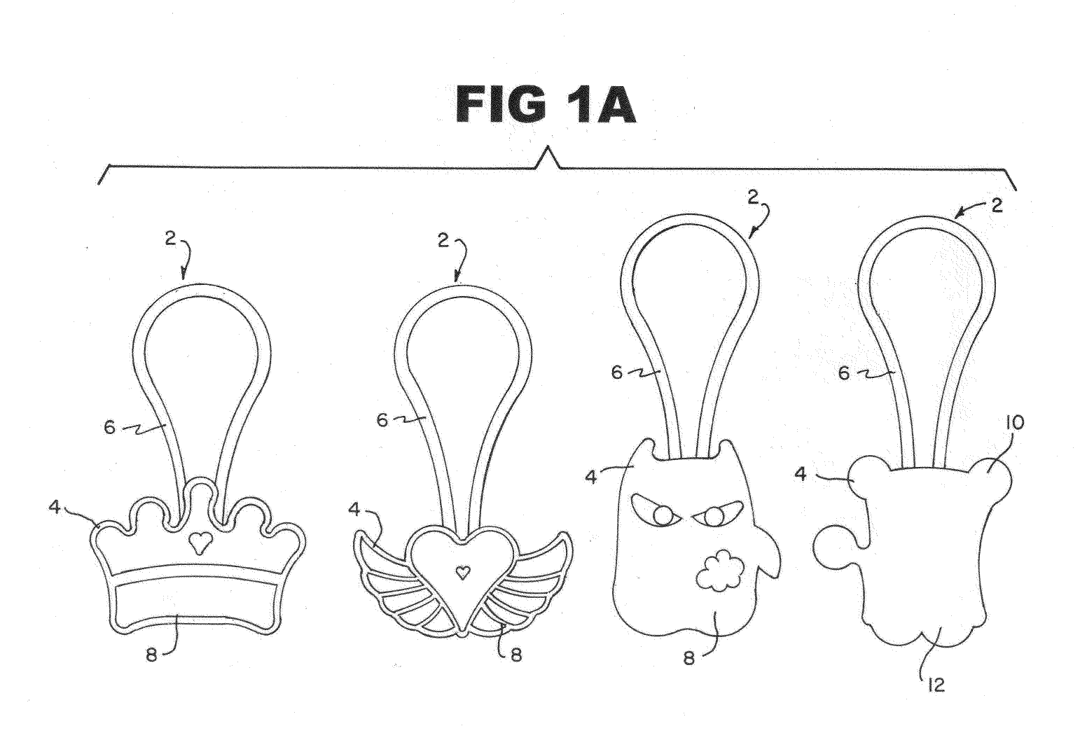

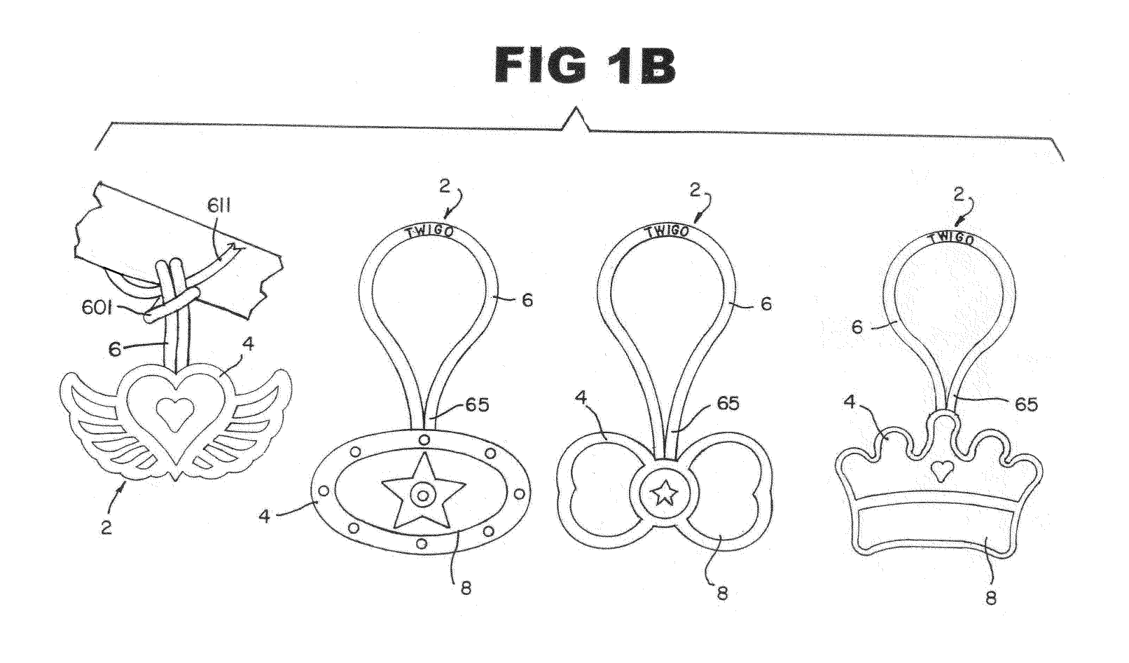

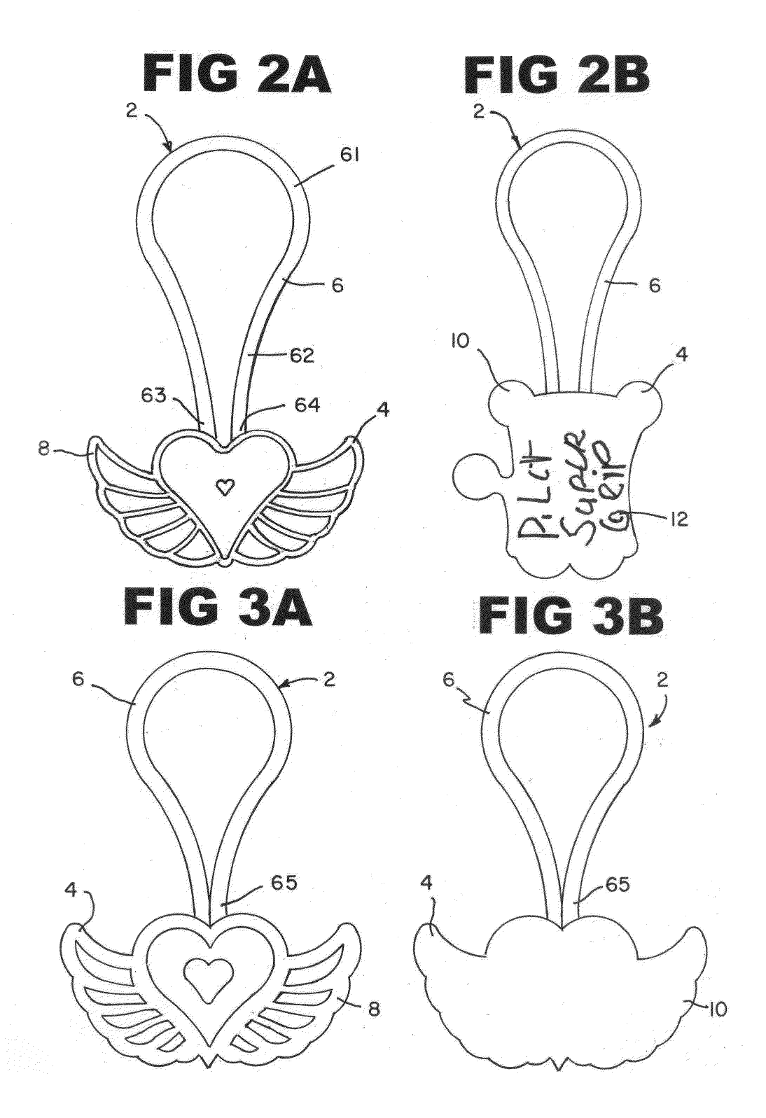

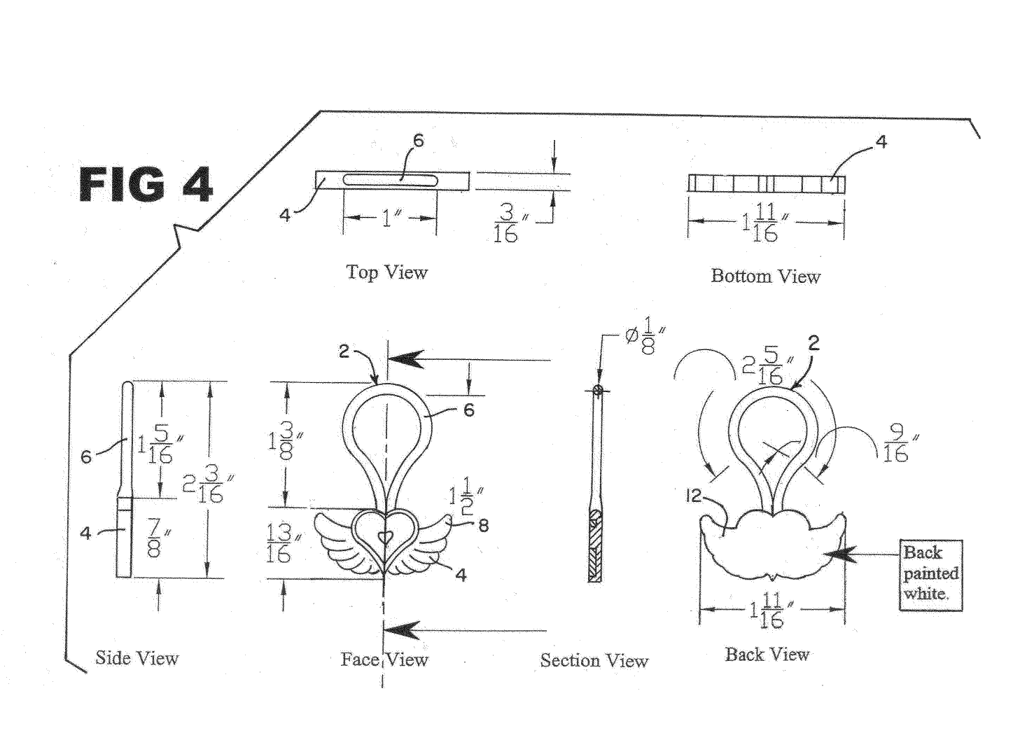

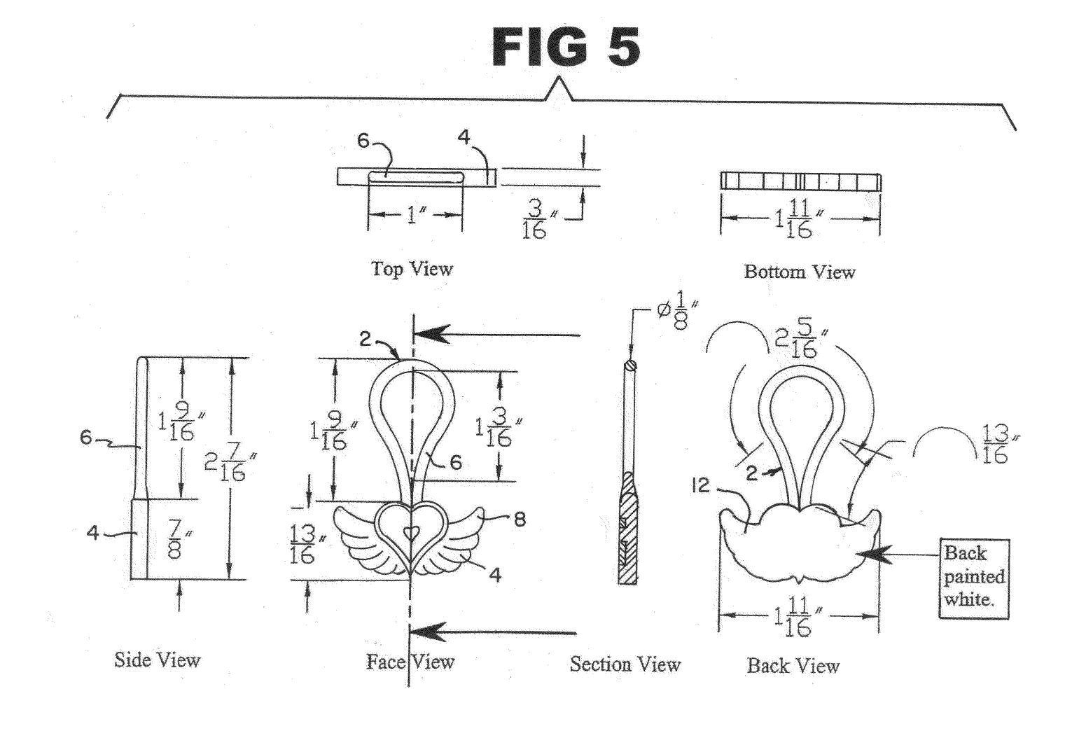

Certain illustrative embodiments of the present invention will now be described with reference to the drawings. In some embodiments as shown in FIGS. 1A, 1B, 2A, 2B, 3A, 3B, 4, and 5, a tag 2 includes an elastic attaching mechanism 6, which can take the form of a band, and a body 4. The body can include two main outer surfaces, i.e., a front surface 8 and back surface 10. The body can be substantially planar and has a thickness much smaller than the dimension of its front/back surface. The side surface of the body along the thickness dimension is also referred to herein as the periphery or peripheral surface of the body. The band 6, which is integrally formed with the body (e.g., injected in the same injection mold), extends substantially from one side of the peripheral surface of the body to form a closed loop. In its undeformed state, the band 6 can be substantially co-planar with the body. The loop formed by the band can have a distal portion 61 that is wider than the proximal portion 62. The band can include two ends (63, 64) each separately extending from a same side of the peripheral surface of the body (such as those embodiments depicted in FIGS. 1A, 2-3), or the band can extend from the body from a common joined end 65 (such as depicted in FIGS. 1B, 3A, 3B, 4, 5, and 7).

As illustrated by FIG. 1B, the band 6 and the body 4 are configured or dimensioned such that the band can be wrapped or placed around an appendage 611 of the object to allow the body to be inserted through an opening formed by a portion of the loop and the appendage, thereby forming a knot 601 (e.g., a girth hitch knot, by tightening the loop after the body is inserted through the loop) that secures the tag onto the object. In such a manner, the tag can be attached onto a target object without the need to manipulate a clasp or tie a rope. Similarly, the tag 2 can be easily removed by loosening the knot and pulling the body 4 back out through the loop. As such, the tag 2 can be easily attached to any loop, ring, collar or other appendage associated with a target object. The target object may be, but is not limited to, a pet, backpack, luggage or any other object which may be tagged with information or identification. For instance, the tag 2 may be attached to a pet collar, pet leash or the strap or handle of a backpack or other type of luggage.

In some embodiments, the elastic attaching mechanism 6 is made from silicone. In one embodiment, both the body 4 and the attaching mechanism 6 are made from silicone. When tag 2 is made of silicone, the tag does not make much noise as it moves around or comes into contact with other objects or surfaces. The tag 2 is also weather and waterproof, washable and leaves no marks on the target object or handler. The ease of attachment and removal, and the durability of silicone, facilitates the frequent re-use of the tag 2. For instance, the same tag 2 can be used on a backpack during the week, on a duffle bag during the weekend and on a suitcase for an extended trip. Furthermore, the elasticity of the silicone band allows the band to fit around handles or other appendages of different sizes.

The body 4 may be any size or shape and can include a design that is shaped as a heart, a crown, a sheriff's badge, a bone or the likeness of an animal or figurine, any other shape, appearance, or structure as desired by the user. In one embodiment, the tag 2 can be a medical identification tag, or a medical alert badge, and is either in the shape of, or includes, a medical symbol. The front surface can further include features, patterns, and/or colors for enhancing the visual appearance or facilitating easy identification of the tag.

In one embodiment, one of the main surfaces, e.g., the back side 10, can include a writing surface 12. As the attaching mechanism 6 is distinct from the body 4 of tag 2, tag 2 can be attached to different sized appendages without distorting the body 4 or the writing or marking on the writing surface of the body 4. In one embodiment, the writing surface 12 can be covered with a polyurethane (PU) coating. As an example, a matte UV PU coating can be prepared by applying (e.g., spraying) a water-based UV-curable PU dispersion, which has excellent adherence to a wide range of substrates and is environmentally friendly (because water is used as a solvent). For example, the various PU dispersions having solid contents of about 38 to 50%, offered by Bayer under the trademark BAYHYDROL®, can be used as the UV-curable PU dispersion herein. Preferably, the PU coating has a high level of chemical and mechanical resistance for indoor and outdoor use. The PU coating on the writing surface 12 is preferably white, but may be another color. The matte PU coating surface may be written upon with, for instance, a simple ball point pen. The writing may subsequently be made permanent through an oil-based ink curing process where the writing surface 12, or entire tag 2, is heated at a predetermined temperature for a duration of time. The curing can be done using common home appliances that contain a heater element, e.g., an oven. In one example, the curing of the writing can be achieved by placing the body or the entire tag in boiling water for approximately three minutes, or some other amount of time. Upon curing, the oil-based ink of the writing is integrated onto the PU coating, thereby improving the durability of the writing.

In one embodiment, the tag 2 is made using a family cavity mold and a double shot mold process where the tag 2 is molded as two parts that are fused together. For example, in a tag 2 where the body 4 is shaped as a heart with wings and includes surface features such as colored details, the base shape—the heart with wings and the attaching band—can be molded as one-piece in a first injection mold by injecting a first injectable material (e.g., silicone) into the mold. Then the molded part is transferred to a second injection mold and used as an insert in the second injection mold. During the second injection molding process, additional injectable material, such as silicone or other material, mixed with desired pigment or other coloration materials, can be injected to add the surface features on one side of the heart with wings to form a completed body. In one embodiment, the tag 2 is molded using a mold having approximately Shore A 50-65 level hardness material. Such injection-molded tag can then be painted on one side of the body with a UV-curable PU dispersion, to obtain a writing surface, which can be further written upon, followed by curing as described herein.

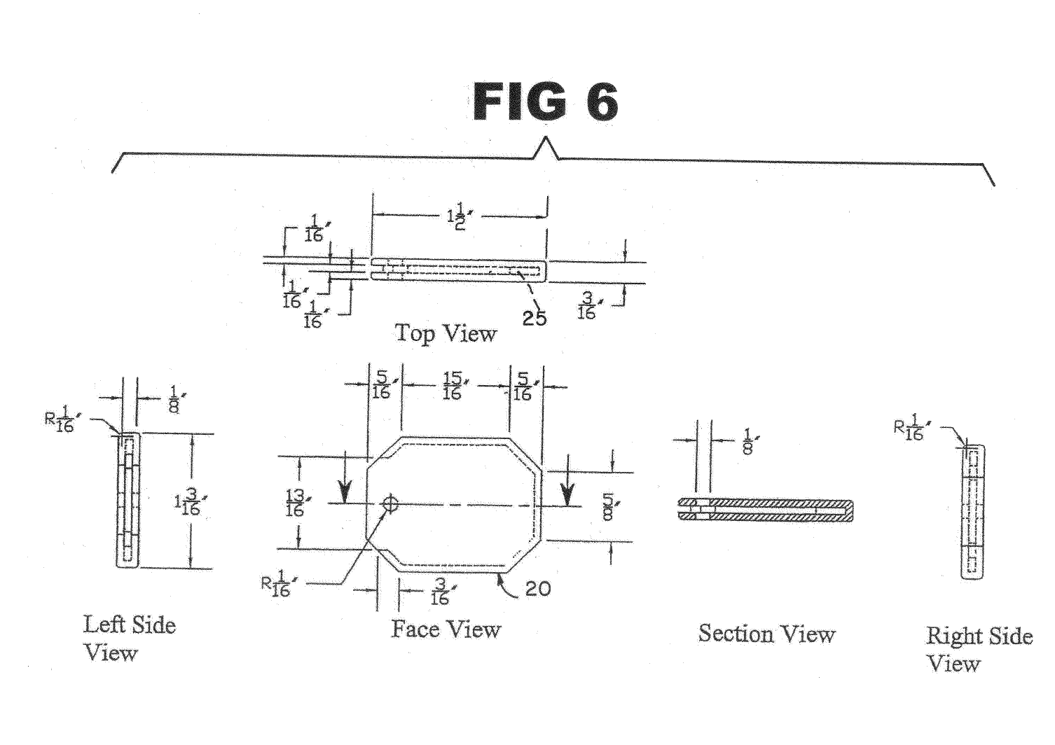

In some embodiments, and as illustrated in FIG. 6, the tag 20 can be made from silicone and has a body including an internal cavity (or pocket) 25 adapted to receive another pre-existing tag, such as a metal tag, or a tag made from another material. The tag 20 can make the existing tag silent, protects any engraving on the existing tag from rubbing off, keeps the tag clean and keeps the target object, or handler, clean by preventing dirty marks on the tag from rubbing off. The tag 20 can include an opening for the cavity on a portion of the peripheral surface of the body to insert the pre-existing tag. In one embodiment, the tag 20 is shaped as a hexagon that stretches and fits around tags of different sizes and shapes, including, but not limited to, tags that are square, round, triangular or custom shaped (such as tags in the shape of a heart, bone or a dog house). The tag 20 can be thin, flexible and stretchable, but also be durable and semi-transparent.

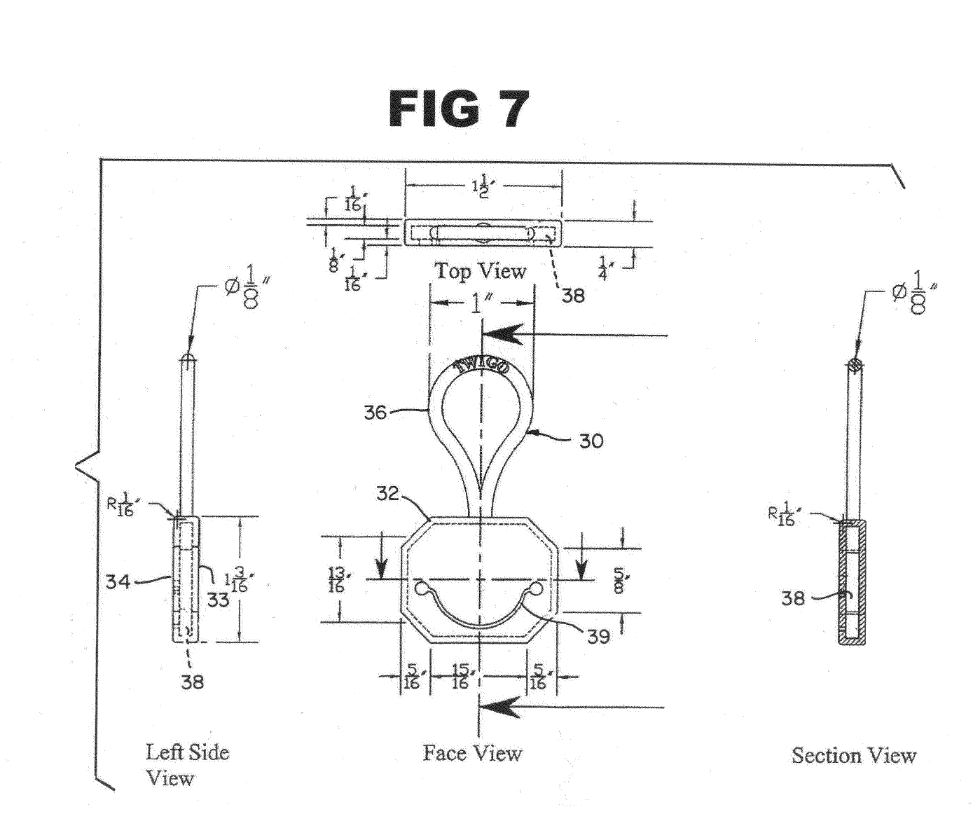

In other embodiments, and as illustrated in FIG. 7, the tag 30 includes a body 32, which can be made from silicone having two main outer surfaces (e.g., a front surface 33 and a back surface 34), and an internal cavity between the two main outer surfaces to receive a pre-existing tag, as well as an attaching mechanism (e.g., a band) 36 which can also be made from silicone, integrally formed with the body 32, and forms a closed loop. A molded logo 31 can be included in the band. The cavity 38 can have an opening 39 formed on one of the main surfaces of the body 35 for inserting a pre-existing tag. The band 36 and the body 32 are configured such that the tag 30 can self-attach to a target object via a girth hitch knot as in the various embodiments described herein. Although shown as an octagonal shape in FIG. 7, the body 32 can also be shaped as a crown, a sheriff's badge, bone or the likeness of an animal or figurine, as described in other examples herein.

Although certain embodiments of the invention have been shown and described, many features may be varied, as will readily be apparent to those skilled in this art. Thus, the foregoing description is merely illustrative and not limiting.

What is claimed is:

1. A tag for labeling an object, comprising:
a body including two main opposing outer surfaces and a peripheral surface therebetween; and
an elastic band integrally formed with the body and extending substantially from one side of the peripheral surface of the body to form a closed loop,
wherein the body and the band are configured such that the band can be placed around an appendage of the object to allow the body to be inserted through an opening formed by a portion of the loop and the appendage, thereby forming a knot that secures the tag onto the object.

2. The tag of claim 1, wherein the band is made from silicone.

3. The tag of claim 1, wherein the body and the band both comprises silicone.

4. The tag of claim 1, wherein the body is substantially planar.

5. The tag of claim 5, wherein the body is shaped as one of an animal, a heart, a bone, a badge, and a medical symbol.

6. The tag of claim 1, wherein one of the main surfaces includes a writing surface adapted to be written upon by a user using a writing device.

7. The tag of claim 6, wherein the writing surface includes a curable polyurethane coating.

8. The tag of claim 6, wherein the main surface that comprises the writing surface has a color different from that of the other of the main surfaces.

9. The tag of claim 1, wherein the band extends from the body from a common joined end.

10. The tag of claim 1, wherein the band includes two ends each separately extending from the one side of the peripheral surface of the body.

11. The tag of claim 1, wherein the band has a cross section which is substantially round.

12. The tag of claim 1, wherein the band further includes a molded logo.

13. The tag of claim 1, wherein the body includes an internal cavity adapted to receive a pre-existing tag.

14. The tag of claim 13, wherein the internal cavity includes an opening in the peripheral surface which allows insertion of the pre-existing tag.

15. The tag of claim 13, wherein the internal cavity includes an opening at one of the main surfaces of the body which allows insertion of the pre-existing tag.

16. A tag for labeling an object, comprising:
a body made from silicone, the body being substantially planar and including two main opposing outer surfaces and a peripheral surface therebetween, and further including an internal cavity adapted to receive an existing tag.

17. The tag of claim 16, further comprising:
a band made from silicone and integrally formed with the body, the band extending substantially from one side of the peripheral surface of the body to form a closed loop,
wherein the body and the band are configured such that the band can be placed around an appendage of the object and to allow the body to be inserted through an opening formed by a portion of the loop and the appendage, thereby forming a knot for securing the tag onto the object.

18. A method for making a tag for labeling an object, comprising:
injecting a first injectable material into a first injection mold to form a base shape, the base shape including a body having two main opposing outer surfaces and a peripheral surface therebetween, and a band integrally formed with the body as one piece and extending substantially from one side of the peripheral surface of the body to form a closed loop;
transferring the base shape into a second injection mold, the second injection mold including remaining space for receiving further injectable material at one side of one main outer surface of the body; and
injecting further injectable material into the remaining space in the second injection mold to form surface features on one main outer surface of the body.

19. The method of claim 18, wherein the first injectable material is silicone.

20. The method of claim 18, further comprising:
applying a polyurethane coating to the other main outer surface of the body that does not have the surface features.

21. The method of claim 20, wherein applying the polyurethane coating comprises applying a water-based UV-curable polyurethane dispersion.

22. A method for using a tag for labeling an object, the tag comprising a body including two main outer opposing surfaces and a peripheral surface therebetween, and an elastic band integrally formed with the body and extending substantially from one side of the peripheral surface of the body to form a closed loop, the method comprising:
placing the band around an appendage of an object;
inserting the body through an opening formed between a portion of the loop and the appendage; and
tightening the loop, thereby forming a knot that secures the tag onto the object.

23. A method for creating a tag for labeling an object, comprising:
receiving a tag comprising a body including two main outer opposing surfaces and a peripheral surface therebetween, and an elastic band integrally formed with the body and extending substantially from one side of the peripheral surface of the body to form a closed loop, wherein at least one of the main surfaces of the tag includes a polyurethane coating;
marking an indicia on the polyurethane coating using an oil-based ink; and
curing the indicia into the polyurethane coating by applying heat, thereby improving the durability of the indicia.

24. The method of claim 23, wherein curing the indicia comprises immersing at least a portion of the body including the marked indicia into boiling water for a predetermined duration of time.

25. The method of claim 24, wherein the predetermined duration of time is about 3 minutes.

26. The method of claim 23, wherein the polyurethane coating comprises UV-curable polyurethane.
